(19) United States
(12) Patent Application Publication
(10) Pub. No.: US 2023/0260500 A1
(43) Pub. Date: Aug. 17, 2023

(54) ACOUSTIC LEVITATION APPARATUS AND METHOD FOR ADAPTIVELY ADJUSTING RESONANCE DISTANCE

(71) Applicant: Institute of Acoustics, Chinese Academy of Sciences, Beijing (CN)

(72) Inventors: Pengfei WU, Beijing (CN); Xiaozhen WANG, Beijing (CN); Jinbiao GAO, Beijing (CN); Qin CHANG, Beiling (CN); Delong XU, Beijing (CN); Weijun LIN, Beijing (CN)

(73) Assignee: Institute of Acoustics, Chinese Acadaemy of Sciences, Beijing (CN)

(21) Appl. No.: 18/168,609

(22) Filed: Feb. 14, 2023

(30) Foreign Application Priority Data
Feb. 15, 2022 (CN) 2022101374980

(51) Int. Cl. G10K 15/00

(52) U.S. Cl. CPC G10K 15/00

(57) ABSTRACT

An acoustic levitation apparatus and method for adaptively adjusting a resonance distance. The apparatus includes an acoustic receiver, an acoustic transmitter, a motor, a slide, and a signal feedback control module. The acoustic receiver and the acoustic transmitter are installed on the slide of which movement is controlled by the motor. The acoustic receiver is connected to the signal feedback control module. The signal feedback control module performs determination by detecting the magnitude of a signal outputted by the acoustic receiver and automatically controls the motor to adjust a spacing between the acoustic transmitter and the acoustic receiver to satisfy a resonance condition to form stable standing wave levitation. The acoustic transmitter is connected to an ultrasonic generator.

### TECHNICAL FIELD

The present invention belongs to the field of acoustic levitation applications, and in particular to an acoustic levitation apparatus and method for adaptively adjusting a resonance distance.

### BACKGROUND

Standing wave acoustic levitation is an important levitation method. During levitation, a certain distance (which is approximately an integer times a half wavelength of an acoustic wave in a medium around a levitated object, called a resonance condition) needs to be satisfied between a transmitting transducer and a reflector to make an object levitate in a specific area. However, when the frequency of the transducer drifts or the speed of sound changes in a medium in the transducer due to a temperature change or for another reason, the wavelength of the acoustic wave in the medium around the levitated object changes. An original distance no longer satisfies the resonance condition, and the distance needs to adjusted again to satisfy the resonance condition. In conventional methods, a resonance distance needs to be estimated through an approximation formula, and the distance between a levitation transducer and a reflector is adjusted manually or by using a control motor (for example, Chinese Utility Model Patent CN214621971U) to make the distance satisfy the resonance condition. This method is inefficient, relies on an operator's experience, and has poor controllability. Disclosed in Chinese Patent Application CN110031501A is an in-situ observation device and observation method for solidification of liquid metal in microgravity. The device includes an ultrasonic levitation system and an acoustic field visualization system. The ultrasonic levitation system is configured to levitate a liquid metal sample in the air, and the acoustic field visualization system is configured to display a generated acoustic standing wave field and to visualize changes in the acoustic standing wave field during the cooling of the liquid metal in microgravity for real-time observation. However, in the patent, a camera is used to observe a sound field distribution or the status of a levitated object, that is, a “seeing” method is used to determine whether a distance satisfies a resonance condition. In this method, it is still necessary to manually observe and analyze images to adjust a resonance distance, and it is difficult to implement the adaptive adjustment of the resonance distance without relying on human intervention.

### SUMMARY

An objective of the present invention is to provide an acoustic levitation apparatus and method for adaptively adjusting a resonance distance. The apparatus and method do not rely on an operator. A receiving transducer performs “listening” to acquire the sound pressure distribution and performs feedback and automatic control, thereby implementing the adaptive adjustment of a resonance distance of acoustic levitation. The present invention may be used to adjust a levitation resonance distance before a levitated object is placed, and more importantly is used to adjust a resonance distance when the frequency of a transducer drifts or the speed of sound changes in a medium between the transducers due to a temperature change or for another reason and a levitated object becomes unstable, thereby improving the stability of levitation.

To achieve the foregoing objective, the following technical solutions are used in the present invention:

An acoustic levitation apparatus for adaptively adjusting a resonance distance is provided, the apparatus including an acoustic receiver, an acoustic transmitter, a motor, a slide, and a signal feedback control module;

the acoustic receiver and the acoustic transmitter are disposed on the slide, the motor is drive-connected to the slide, a standing wave field is formed between the acoustic receiver and the acoustic transmitter, the acoustic receiver is connected to the signal feedback control module, and the signal feedback control module is communicatively connected to the motor and controls the motor to drive the slide to move to further adjust a resonance distance between the acoustic receiver and the acoustic transmitter; and

the acoustic transmitter is connected to an ultrasonic generator.

Preferably, the radiating surface of the acoustic transmitter is a plane surface or a concave surface. An ultrasonic transducer may be used.

Preferably, the surface of the acoustic receiver is a plane surface or a concave surface. The acoustic receiver is used as a reflecting surface and is also used for measuring an acoustic pressure. A receiving transducer may be chosen, or a reflecting surface bonded with a piezoelectric ceramic sheet may be chosen.

In the present invention, the acoustic transmitter and the acoustic receiver may be designed as concave spherical surfaces to generate a focusing acoustic field, thereby increasing the capability and stability of acoustic levitation.

In the present invention, the acoustic levitation apparatus may be of a single-axis type or may be of a multi-axis type. If the acoustic levitation apparatus is of a multi-axis type, the ultrasonic generator may output a multi-path intra-frequency high power signal, to drive a plurality of transducers to operate efficiently.

Preferably, the ultrasonic generator is provided with a matcher, and a matching parameter may be adjusted for use with ultrasonic transducers with different frequencies.

In the present invention, an ultrasonic frequency is 20 kHz and above, a high frequency is used when a small-size object needs to be levitated, and a low frequency is used when a large-size object needs to be levitated.

In the present invention, referring to a flowchart of feedback for adaptive adjustment, a microcontroller is used to control a liftable device such as a motor to adjust a distance of a resonance cavity.

The present invention further provides an acoustic levitation method for adaptively adjusting a resonance distance, the method including the following steps:

1) forming a standing wave field by using an acoustic receiver as a reflector and making a spacing between the reflector and an acoustic transmitter satisfy a resonance condition;

2) measuring, by an acoustic receiver, acoustic pressure of a radiated acoustic wave of the acoustic transmitter, and converting an acoustic pressure signal into a voltage signal to be inputted into a signal feedback control module;

3) controlling, by the signal feedback control module, a motor to fine-tune a spacing between the acoustic transmitter and the acoustic receiver, detecting, by the signal feedback control module, a voltage value outputted by the acoustic receiver, and determining stability of levitation according to a change in the voltage value; and

4) when a levitated object becomes unstable under the influence of a frequency change or a temperature change, controlling the motor by using the signal feedback control module to drive the acoustic transmitter or the acoustic receiver to move, and adjusting a distance between the acoustic transmitter and the acoustic receiver, so that the resonance condition is satisfied when a voltage amplitude measured by the acoustic receiver reaches a maximum value, making the levitated object satisfy stable levitation in a levitation apparatus.

In step 3), the principle of determining stability of levitation according to a change in the voltage value is specifically:

When a levitation system becomes stable, the voltage value outputted by the acoustic receiver is decreased by increasing or decreasing the spacing between the acoustic transmitter and the acoustic receiver. When the levitation system is unstable, the voltage value outputted by the acoustic receiver is increased by either of increasing and decreasing the spacing between the acoustic transmitter and the acoustic receiver.

A resonance distance between the acoustic transmitter and the acoustic receiver is specifically adjusted in step 4) in one of two manners as follows:

a manner 1: after the signal feedback control module receives the voltage signal, increasing the resonance distance, and after the resonance distance is increased, if an amplitude of the acoustic pressure signal measured by the acoustic receiver continues to increase, continuing to increase the resonance distance until the amplitude of the acoustic pressure signal measured by the acoustic receiver satisfies a maximum value, that is, the resonance distance is adjusted successfully; and after the resonance distance is increased, if the acoustic pressure signal measured by the acoustic receiver decreases, decreasing the resonance distance until the amplitude of the acoustic pressure signal measured by the acoustic receiver satisfies the maximum value, that is, the resonance distance is adjusted successfully; and

a manner 2: after the signal feedback control module receives the voltage signal, decreasing the resonance distance, and after the resonance distance is decreased, if the acoustic pressure signal measured by the acoustic receiver continues to increase, continuing to decrease the resonance distance until the acoustic pressure signal measured by the acoustic receiver satisfies a maximum value, that is, the resonance distance is adjusted successfully; and after the resonance distance is decreased, if the acoustic pressure signal measured by the acoustic receiver decreases, increasing the resonance distance until the acoustic pressure signal measured by the acoustic receiver satisfies the maximum value, that is, the resonance distance is adjusted successfully.

In the present invention, different maximum values are generated for different levitated objects or levitation conditions. A maximum value is a value at which stable acoustic levitation is reached during dynamic adjustment of a resonance distance of acoustic levitation.

In the present invention, a levitated object is placed in a standing wave field formed between an acoustic transmitter and an acoustic receiver, where the acoustic receiver is a receiving transducer, and receives ultrasound transmitted by the acoustic transmitter and converts an acoustic signal into an electrical signal. A signal feedback control module detects whether a voltage value outputted by the acoustic receiver satisfies a maximum value to determine whether a spacing between two transducers satisfies a standing wave condition; the signal feedback control module controls a motor by using a microcontroller to drive the acoustic transmitter or the acoustic receiver to move a tiny distance; the amplitude of the voltage outputted by the acoustic receiver is detected again, and if the amplitude of the voltage increases, the movement continues, or if the amplitude of the voltage decreases, the movement is reversed; and a resonance condition is satisfied when the amplitude of the voltage reaches the maximum value, thereby implementing adaptive adjustment of a resonance distance.

In the present invention, the magnitude of an acoustic pressure on an opposite reflector produced by an acoustic wave radiated by a levitation transducer is measured to adjust a spacing of a levitation resonance cavity, which is based on the physical principle that when standing wave acoustic levitation satisfies a resonance condition, the amplitude of the acoustic pressure on the reflector remains at a maximum value. The automatic, adaptive adjustment of a resonance distance of an acoustic levitation apparatus can be implemented by using the method.

### BRIEF DESCRIPTION OF THE DRAWING

FIG. 1 is a schematic structural diagram of an acoustic levitation apparatus according to the present invention; and

FIG. 2 is a flowchart of feedback for adaptive adjustment of a resonance distance according to the present invention.

### DETAILED DESCRIPTION

The present invention is further described below in detail with reference to the accompanying drawings and specific implementations.

### Embodiment 1

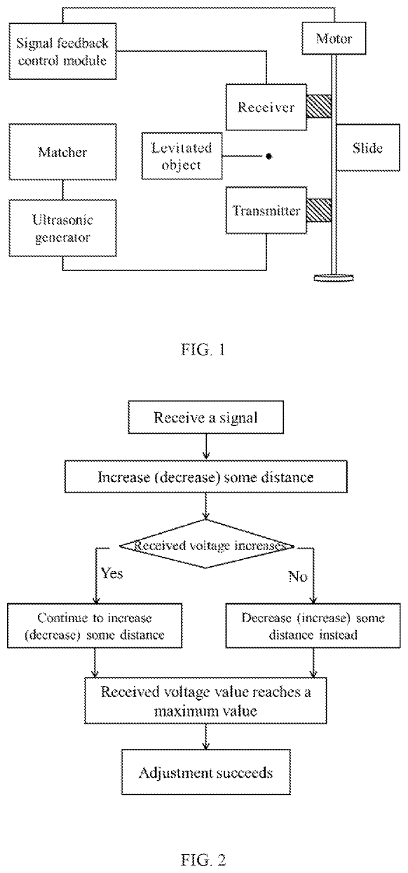

As shown in FIG. 1, an acoustic levitation apparatus for adaptively adjusting a resonance distance is provided, the apparatus including an acoustic receiver, an acoustic transmitter, a motor, a slide, and a signal feedback control module.

The acoustic receiver and the acoustic transmitter are installed on the slide of which movement is controlled by the motor. The acoustic receiver is connected to the signal feedback control module. The signal feedback control module is communicatively connected to the motor and controls the movement of the motor to further adjust a resonance distance between the acoustic receiver and the acoustic transmitter.

The acoustic transmitter is connected to a UGD-type ultrasonic generator. A matcher is disposed at the ultrasonic generator.

An end surface of the acoustic transmitter is a flat surface. A sandwich piezoelectric ceramic transducer may be used. In a connection order, components are sequentially back matching, a piezoelectric ceramic sheet, an electrode sheet, front matching, and a booster.

An Intel-80C51 microcontroller is used for the signal feedback control module, receives a signal outputted by the acoustic receiver, performs a logical operation, and outputs an instruction to control the motor to adjust a distance.

The motor is a servo motor with the model of Panasonic servo motor A6, and is mainly used for controlling the slide to adjust linear displacements of two ends of the levitation apparatus.

The slide is MOTTA-MSR, and is mainly used for adjusting the linear displacements of the two ends of the levitation apparatus.

The surface of the acoustic receiver is a plane surface. The acoustic receiver is used as a reflector and is also used for measuring an acoustic pressure. A sandwich piezoelectric ceramic transducer may be chosen. In a connection order, components are sequentially back matching, a piezoelectric ceramic sheet, an electrode sheet, front matching, and a booster.

In the present invention, the acoustic transmitter and the acoustic receiver may be designed as concave surfaces to generate a focusing acoustic field, thereby increasing the capability and stability of acoustic levitation.

In the present invention, the acoustic levitation apparatus is of a single-axis type. The ultrasonic generator is provided with a matcher, and a matching parameter may be adjusted for use with ultrasonic transducers with different frequencies.

The present invention further provides an acoustic levitation method for adaptively adjusting a resonance distance, which may be used to adjust a resonance distance before a levitated object is placed, and more importantly is used to adjust a resonance distance when the frequency of a transducer drifts or the speed of sound changes in a medium between the transducers due to a temperature change or for another reason and a levitated object becomes unstable, thereby improving the stability of levitation. The method includes the following steps:

1) forming a standing wave field by using an acoustic receiver as a reflector and making a spacing between the reflector and an acoustic transmitter satisfy a resonance condition;

2) measuring, by an acoustic receiver, acoustic pressure of a radiated acoustic wave of the acoustic transmitter, and inputting a measured acoustic pressure signal into a signal feedback control module;

3) controlling, by using a microcontroller, a motor to fine-tune a spacing between the acoustic transmitter and the acoustic receiver, detecting, by the signal feedback control module, a voltage value outputted by the acoustic receiver, and determining stability of levitation according to a change in the voltage value, where the principle is specifically that when a levitation system becomes stable, the voltage value outputted by the acoustic receiver is decreased by increasing or decreasing the spacing between the acoustic transmitter and the acoustic receiver, and when the levitation system is unstable, the voltage value outputted by the acoustic receiver is increased by either of increasing and decreasing the spacing between the acoustic transmitter and the acoustic receiver.

4) controlling the motor according to a determination result of stability of levitation to drive the acoustic transmitter or the acoustic receiver to move, and adjusting a resonance distance between the acoustic transmitter and the acoustic receiver, so that the resonance condition is satisfied when a voltage amplitude measured by the acoustic receiver reaches a maximum value, making the levitated object satisfy stable levitation in a levitation apparatus.

As shown in FIG. 2, a resonance distance between the acoustic transmitter and the acoustic receiver is specifically adjusted in step 4) in one of two manners as follows:

a manner 1: after the signal feedback control module receives the acoustic pressure signal, increasing the resonance distance, and after the resonance distance is increased, if an amplitude of the acoustic pressure signal measured by the acoustic receiver continues to increase, continuing to increase the resonance distance until the amplitude of the acoustic pressure signal measured by the acoustic receiver satisfies a maximum value, that is, the resonance distance is adjusted successfully; and after the resonance distance is increased, if the acoustic pressure signal measured by the acoustic receiver decreases, decreasing the resonance distance until the amplitude of the acoustic pressure signal measured by the acoustic receiver satisfies the maximum value, that is, the resonance distance is adjusted successfully; and

a manner 2: after the signal feedback control module receives the acoustic pressure signal, decreasing the resonance distance, and after the resonance distance is decreased, if the acoustic pressure signal measured by the acoustic receiver continues to increase, continuing to decrease the resonance distance until the acoustic pressure signal measured by the acoustic receiver satisfies a maximum value, that is, the resonance distance is adjusted successfully; and after the resonance distance is decreased, if the acoustic pressure signal measured by the acoustic receiver decreases, increasing the resonance distance until the acoustic pressure signal measured by the acoustic receiver satisfies the maximum value, that is, the resonance distance is adjusted successfully.

In this embodiment, the adaptation may use conventional adaptive algorithms in the field, for example, a zero-forcing algorithm, a steepest descent algorithm, an LMS algorithm, an RLS algorithm, and various blind equalization algorithms, which are embedded in the signal feedback control module can be used.

Conventional technical knowledge in the field may be used for content that is not described in detail in the present invention.

Finally, it should be noted that the foregoing embodiments are merely intended for describing the technical solutions of the present invention rather than limiting the present invention. Although the present invention is described in detail with reference to the embodiments, persons of ordinary skill in the art should understand that they may still make modifications or equivalent replacements to the technical features of the present invention without departing from the spirit and scope of the technical solutions of the technical solutions of the present invention. These modifications or equivalent replacements shall all fall within the scope of the claims the present invention.

1. An acoustic levitation apparatus for adaptively adjusting a resonance distance, wherein the apparatus comprises an acoustic receiver, an acoustic transmitter, a motor, a slide, and a signal feedback control module;
the acoustic receiver and the acoustic transmitter are disposed on the slide, the motor is drive-connected to the slide, a standing wave field is formed between the acoustic receiver and the acoustic transmitter, the acoustic receiver is connected to the signal feedback control module, and the signal feedback control module is communicatively connected to the motor and controls the motor to drive the slide to move to further adjust a resonance distance between the acoustic receiver and the acoustic transmitter; and
the acoustic transmitter is connected to an ultrasonic generator.

2. The acoustic levitation apparatus for adaptively adjusting a resonance distance according to claim 1, wherein the signal feedback control module is a microcontroller.

3. The acoustic levitation apparatus for adaptively adjusting a resonance distance according to claim 1, wherein a matcher is disposed at the ultrasonic generator, and a matching parameter is adjusted to correspond to ultrasonic transducers with different frequencies.

4. The acoustic levitation apparatus for adaptively adjusting a resonance distance according to claim 1, wherein the radiating surface of the acoustic transmitter is a plane surface or a concave surface.

5. The acoustic levitation apparatus for adaptively adjusting a resonance distance according to claim 1, wherein the surface of the acoustic receiver is a plane surface or a concave surface.

6. An acoustic levitation method for adaptively adjusting a resonance distance, the method comprising the following steps:
1) forming a standing wave field by using an acoustic receiver as a reflector and making a spacing between the reflector and an acoustic transmitter satisfy a resonance condition;
2) measuring, by an acoustic receiver, acoustic pressure of a radiated acoustic wave of the acoustic transmitter, and converting an acoustic pressure signal into a voltage signal to be inputted into a signal feedback control module;
3) controlling, by the signal feedback control module, a motor to fine-tune a spacing between the acoustic transmitter and the acoustic receiver, detecting, by the signal feedback control module, a voltage value outputted by the acoustic receiver, and determining stability of levitation according to a change in the voltage value; and
4) when a levitated object becomes unstable under the influence of a frequency change or a temperature change, controlling the motor by using the signal feedback control module to drive the acoustic transmitter or the acoustic receiver to move, and adjusting a distance between the acoustic transmitter and the acoustic receiver, so that the resonance condition is satisfied when a voltage amplitude measured by the acoustic receiver reaches a maximum value, making the levitated object satisfy stable levitation in a levitation apparatus.

7. The acoustic levitation method for adaptively adjusting a resonance distance according to claim 6, wherein a resonance distance between the acoustic transmitter and the acoustic receiver is specifically adjusted in step 4) in one of two manners as follows:
a manner 1: after the signal feedback control module receives the voltage signal, increasing the resonance distance, and after the resonance distance is increased, if an amplitude of the acoustic pressure signal measured by the acoustic receiver continues to increase, continuing to increase the resonance distance until the amplitude of the acoustic pressure signal measured by the acoustic receiver satisfies a maximum value, that is, the resonance distance is adjusted successfully; and after the resonance distance is increased, if the acoustic pressure signal measured by the acoustic receiver decreases, decreasing the resonance distance until the amplitude of the acoustic pressure signal measured by the acoustic receiver satisfies the maximum value, that is, the resonance distance is adjusted successfully; and
a manner 2: after the signal feedback control module receives the voltage signal, decreasing the resonance distance, and after the resonance distance is decreased, if the acoustic pressure signal measured by the acoustic receiver continues to increase, continuing to decrease the resonance distance until the acoustic pressure signal measured by the acoustic receiver satisfies a maximum value, that is, the resonance distance is adjusted successfully; and after the resonance distance is decreased, if the acoustic pressure signal measured by the acoustic receiver decreases, increasing the resonance distance until the acoustic pressure signal measured by the acoustic receiver satisfies the maximum value, that is, the resonance distance is adjusted successfully.
